(19) United States
(12) Patent Application Publication
(10) Pub. No.: US 2026/0338329 A1
(43) Pub. Date: Oct. 29, 2026

(54) SECURING SYSTEM FOR SECURING A PRESSURE TANK

(71) Applicant: NORMA GERMANY GMBH, Maintal (DE)

(72) Inventor: Tarik ADSIZ, Hustopece (CZ)

(21) Appl. No.: 19/115,285

(22) PCT Filed: Sep. 6, 2023
(86) PCT No.: PCT/EP2023/074466

§ 371 Date: Mar. 26, 2025

(30) Foreign Application Priority Data
Sep. 27, 2022 (DE) 10 2022 124 829.1

(51) Int. Cl. F17C 13/08; F16G 11/03

(52) U.S. Cl. CPC F17C 13/08; F16G 11/03; F17C 2201/0109; F17C 2205/0103; F17C 2205/0126; F17C 2205/0153

(57) ABSTRACT

A coupling system for mechanically coupling belts includes coupling interfaces. Each coupling interface includes a rod, a spring element, a spring-travel-limiting element, a connecting element and a securing element. The connecting element being movably arranged on the rod and configured to be connected to a belt. The securing element being fixedly arranged on the rod. The spring element being arranged between the connecting element and the securing element. The spring-travel-limiting element being arranged on the rod between the connecting element and the securing element. The spring-travel-limiting element being shorter than the spring element, such that the spring-travel-limiting element establishes a frictional connection between the connecting element, a belt which is connected to the connecting element, and the rod.

### INTRODUCTION

The proposed disclosure relates to a coupling system, to a securing system, to a pressure tank system, and to a method for securing a pressure tank.

Pressure tanks are often used to store fluids. For this purpose, fluids such as, for example, gases or liquids, are directed under pressure, typically under high pressure, into a pressure tank. The pressure tank expands as a result, or increases in terms of its cross section, respectively. Therefore, pressure tanks should not be fixedly mounted in order not to disturb any expansion during filling.

Securing systems in which pressure tanks are secured to a frame by pre-tensioned straps are known. Here, the respective connectors for connecting the straps and the frame are subjected to significant stress, because in a vehicle said connectors are impinged with enormous acceleration forces by the pressure tank in the event of an accident.

### SUMMARY

It is, therefore, an object of the present disclosure, per an embodiment, to provide an improved possibility for securing a gas pressure tank.

Thus, according to a first aspect of the proposed disclosure, per an embodiment, a coupling system for mechanically coupling straps is proposed. The coupling system comprises a number of coupling interfaces, wherein each coupling interface of the number of coupling interfaces comprises a rod, a spring element, a spring-travel delimiter, a connecting element and a securing element, wherein the connecting element is movably disposed on the rod and is configured to be connected to a strap; wherein the securing element is fixedly disposed on the rod; wherein the spring element is disposed between the connecting element and the securing element; wherein the spring-travel delimiter is disposed between the connecting element and the securing element on the rod; and wherein the spring-travel delimiter is shorter than the spring element in such a way that the spring-travel delimiter establishes a force fit between the connecting element, a strap connected to the connecting element, and the rod when the connecting element pushes by way of a defined force in the direction of the securing element.

In the context of the proposed disclosure, a strap is understood to be a strip of material such as, for example, a band of metal and/or plastics material and/or a woven textile fabric.

In the context of the proposed disclosure, a spring element is understood to be an elastic, thus reversibly deformable, element such as, for example, a mechanical spring.

The proposed coupling system, per an embodiment, is based on the principle that a strap which is disposed on the connecting element of a respective coupling interface is movable per se due to the movable mounting of the connecting element, so that a pressure tank secured by the strap can expand and contract without losing contact with the strap.

In particular, the connecting element is configured to engage in a loop formed by a strap. Of course, a respective strap can also be connected in another way, for example by being screwed or clamped to the connecting element.

As a result of the spring-travel delimiter provided according to the disclosure, per an embodiment, a force fit is caused between the connecting element and a strap which has the securing element and is disposed on the connecting element, and consequently with the rod, when the spring element is compressed, or when the connecting element pushes the spring-travel delimiter onto the securing element. This means that in a compressed state of the spring element, the force flux between the coupling system and a pressure tank to be secured is directed about the spring element by way of a “bypass”, and the spring element is consequently destressed.

This furthermore means that in a compressed state of the spring element, the coupling system is rigid or stiff in such a way that any further impingement by a force beyond a point at which the spring-travel delimiter pushes onto the securing element leads to a direct introduction of force into the rod and into a respective strap. Accordingly, a deformation of a respective pressure tank up to a predefined geometrical limit is tolerated by the spring element in such a way that the coupling system is deformed conjointly with the pressure tank. In the event of the pressure tank being deformed beyond the predefined geometrical limit, for example when the pressure tank moves out of its mounting in the event of a collision with an obstacle, the deformation tolerance of the coupling system is exceeded, and the coupling system behaves rigidly in order to secure the pressure tank in its position. Accordingly, the coupling system alternates between two states, a compressed state having a predefined holding force, and a rigid state having a maximum holding force.

Furthermore, the spring-travel delimiter causes a restriction of a potential introduction of force into the spring element in such a way that the spring element is protected from excessive stress, and material faults due to overloading are avoided. Accordingly, a life span or service life of the spring element, and consequently a life span or service life of the coupling system, can be reliably and exactly specified independently of the type of its use.

Owing to the fact that the spring-travel delimiter is shorter than the spring element, the spring element can be compressed within a predefined range, specifically up to a detent of the spring-travel delimiter and expand up to a maximum deflection position of the connecting element.

As a result of the deflection of the spring element, a respective strap disposed on the connecting element is held under mechanical tension even when a respective pressure tank contracts. In the process, a length of a spacing between the maximum deflection position of the connecting element and the securing element, and a spring rate of the spring element, determines a holding force by way of which the strap, or the coupling system, acts on the pressure tank. Accordingly, the holding force can be adjusted by adjusting or displacing the securing element on the rod.

It can be provided that the rod has a thread for screwing the securing element thereto only in regions, wherein the securing element is a threaded nut, and wherein the thread ends in a region which in the relaxed state of the coupling system is spaced apart from the connecting element by a distance greater than a length of the spring-travel delimiter.

A thread for screwing the securing element to the rod, which is formed only in regions on the latter, predefines a holding force by way of which the coupling system secures a respective pressure tank in a relaxed position of the spring element. Accordingly, a length of the thread can be adapted in order to adapt the holding force. Of course, a position of the securing element on the rod may also be changed in order to adapt the holding force.

Furthermore, a thread which is formed in regions has the effect that the spring element is impinged with a predefined torque for tensioning the coupling system.

It is provided in particular that the securing element comprises a threaded nut and a contact disk, so that the spring element is in contact with the securing element by way of the contact disk.

It can furthermore be provided that the securing element is a fixed material protrusion of the rod, which ends in a region which in the relaxed state of the coupling system is spaced apart from the connecting element by a distance greater than a length of the spring-travel delimiter.

A fixed material protrusion such as, for example, a shank which can be machined during the production of the rod, or welded thereto, causes an exactly predefined holding force of the coupling system.

It can furthermore be provided that the spring-travel delimiter is movably disposed between the connecting element and the securing element on the rod, or is fixedly disposed on the securing element.

A spring-travel delimiter which is fixedly disposed on the securing element can be designed, for example, as an integral or monolithic constituent part of the securing element. A movably designed spring-travel delimiter can be hollow, for example, and be guided about the rod, thus disposed on the rod.

It can furthermore be provided that the coupling system comprises two coupling interfaces which are conjointly disposed on a rod.

Two coupling interfaces which are disposed on a common rod enable two straps to be connected by a compact coupling system in which a force fit between the rod and the two straps is established in a compressed state of the two spring elements. For example, a securing element which is fixedly formed on a first end of the rod, and a securing element which is screwed to a second end, opposite the first end, can be provided here so that all of the components of the two coupling interfaces can be pushed onto the rod and finally secured by the securing element screwed to the latter.

According to a second aspect, the proposed disclosure, per an embodiment, relates to a securing system for securing a round pressure tank. The securing system comprises a strap system and a number of potential design embodiments of the proposed coupling system; wherein the strap system comprises a multiplicity of straps; wherein the strap system is configured to be connected to a first holding point and a second holding point and to encompass the pressure tank between the first holding point and the second holding point; and wherein the strap system is mechanically coupled to the number of coupling systems.

The proposed securing system, per an embodiment, serves in particular to secure a pressure tank on a number of, in particular two, holding points.

It can be provided that the strap system comprises a first strap which on its first end is connectable to the first holding point, and on its second end is connected to a connecting element of a coupling system of the number of coupling systems; and the strap system comprises a second strap which on its second end is connectable to the second holding point, and on its second end is connected to a connecting element of a coupling system of the number of coupling systems.

A securing system having a strap system consisting of in particular two straps which engage in a coupling system in such a way that the coupling system connects the straps, establishes a force fit between holding points connected to the straps, the straps, and the coupling system. Accordingly, the securing system enables a pressure tank to be secured on the respective holding points. For this purpose, the straps can be connected to respective holding points, in particular hooked into the holding points, or be screwed or clamped to the holding points. For example, a strap can form a lug in which a, for example hook-shaped, holding point engages.

It can furthermore be provided that the securing system comprises a first coupling system and a second coupling system. It can be provided here that the strap system comprises three straps, wherein a first strap of the strap system on its first end is connectable to the first holding point, and on its second end is connected to a first connecting element of the first coupling system; wherein a second strap of the strap system on its first end is connected to a second connecting element of the first coupling system, and on its second end is connected to a first connecting element of the second coupling system; and wherein a third strap of the strap system on its first end is connected to a second connecting element of the second coupling system, and on its second end is connectable to the second holding point.

A strap system consisting of three straps and two coupling systems enables particularly voluminous pressure tanks to be secured. In the process, a second strap which is connected to both coupling systems can be adapted in terms of its length, for example, in order to be adapted to a volume of the pressure tank.

According to a third aspect, the proposed disclosure, per an embodiment, relates to a pressure tank system for storing a fluid. The pressure tank system comprises a round, in particular cylindrical, pressure tank, a frame having a first holding point and a second holding point, and a potential design embodiment of the proposed securing system; wherein the securing system encases the pressure tank at least in regions; and wherein the securing system is connected to the first holding point and the second holding point.

A pressure tank system having a frame on which the securing system is disposed can be transported easily and safely, independently of a filling state of the pressure tank.

According to a fourth aspect, the proposed disclosure, per an embodiment, relates to a method for securing a pressure tank, in which method a pressure tank having a potential design embodiment of the proposed securing system is secured on a number of holding points. As a result of the spring elements of the securing system, the pressure tank is secured on the holding points, in particular pushed into the frame, by way of a minimum securing force even in a non-filled state, in such a way that any sliding of the pressure tank out of the frame is prevented even at low acceleration forces. As a result of the securing system being connected to the holding points, the spring elements are compressed up to the detent of the spring-travel delimiter at high acceleration forces, and a force fit between the securing system and the frame is established in such a way that the pressure tank is securely held in the frame even at high acceleration forces.

The proposed securing system, per an embodiment, serves in particular for carrying out the proposed method.

### BRIEF DESCRIPTION OF THE FIGURES

Further features, details and advantages of the disclosure are derived from the wording of the claims, and from the description hereunder of exemplary embodiments by means of the drawings, in which:

FIG. 1 shows a potential design embodiment of the proposed securing system having two potential design embodiments of the coupling system;

FIG. 2 shows a longitudinal section of the securing system according to FIG. 1;

FIG. 3 shows a potential design embodiment of the pressure tank system;

FIG. 4 shows a cross-section of the pressure tank system according to FIG. 3;

FIG. 5 shows a detailed view of a coupling system of the pressure tank system according to FIG. 3;

FIG. 6 shows an additional potential design embodiment of the coupling system; and

FIG. 7 shows a longitudinal section of the coupling system according to FIG. 6.

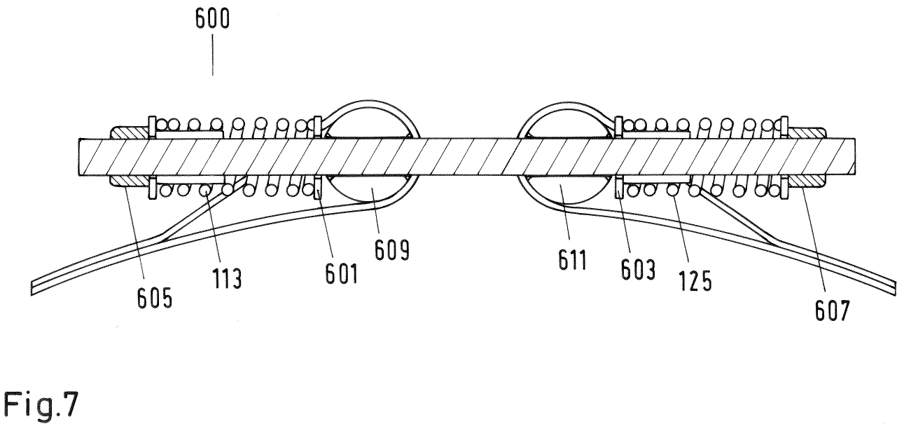

### DETAILED DESCRIPTION

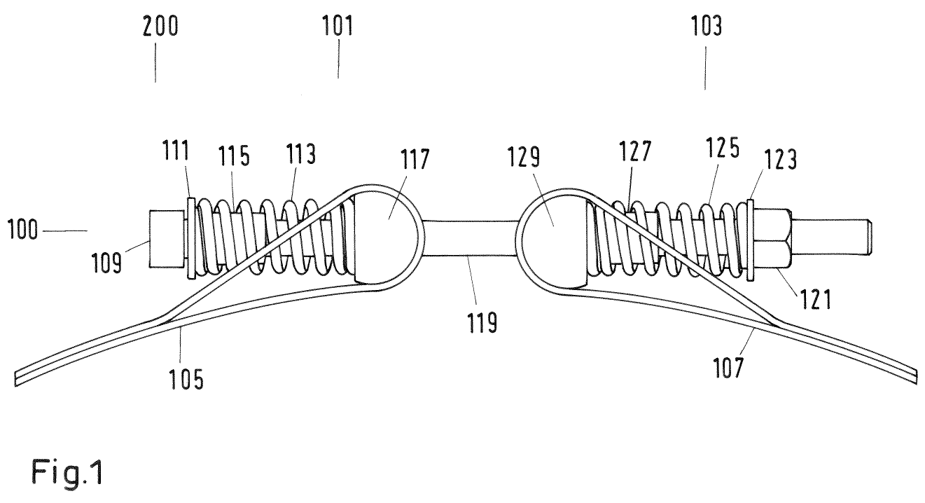

A coupling system 100 is illustrated in FIG. 1. The coupling system 100 is part of a securing system 200 and comprises a first coupling interface 101 and a second coupling interface 103, and a first strap 105 and a second strap 107.

The first coupling interface 101 comprises a first securing element 109, a first contact disk 111, a first spring element 113, a first spring-travel delimiter 115 and a first connecting element 117 which are in each case disposed on a rod 119.

The first connecting element 117 is movable between a first end point, at which the first spring element 113 is completely deflected, and a second end point at which the first connecting element 117 meets the first spring-travel delimiter 115. The first endpoint can optionally be predefined by a detent formed on the rod 119.

The first strap 105 by way of a loop encompasses the first connecting element 117 in such a way that the first spring element 113 keeps the first strap 105 continuously tensioned. When the first strap 105 is impinged by a tensile force, for example due to a movement of a pressure tank secured by the first strap 105, said first strap 105 pulls, or pushes, the first connecting element 117 onto the first spring element 113, the latter being compressed until the first connecting element 117 meets the first spring-travel delimiter 115 and forms a force fit between the first strap 105, the first contact disk 111, and the first securing element 109 or the rod 119, respectively, so that any further movement of the first strap 105 is prevented and the pressure tank is secured in its position.

The second coupling interface 103 comprises a second securing element 121, a second contact disk 123, a second spring element 125, a second spring-travel delimiter 127 and a second connecting element 129 which are in each case disposed on the rod 119.

The second connecting element 129 is movable between a first end point at which the first spring element 125 is completely deflected, and a second end point at which the second connecting element 129 pushes the second spring-travel delimiter 127 onto the second contact disk 123. The second endpoint can optionally be predefined by a thread which is formed in regions on the rod 119.

The second strap 107 by way of a loop encompasses the second connecting element 129 in such a way that the second spring element 125 keeps the second strap 107 continuously tensioned. When the second strap 107 is impinged with a tensile force, for example due to a movement of a pressure tank secured by the second strap 105, said second strap 105 pulls, or pushes, the second connecting element 129 and the second spring-travel delimiter 127 onto the second contact disk 123 in such a way that a force fit is formed between the second strap 107, the second contact disk 123, and the second securing element 121 or the rod 119, respectively, so that any further movement of the second strap 107 is prevented and the pressure tank is secured in its position.

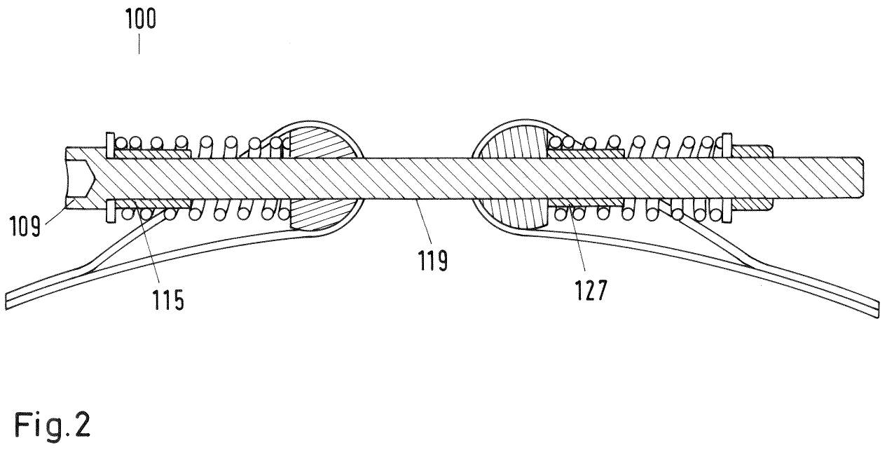

The coupling system 100 is illustrated in a sectional view in FIG. 2. It can be seen here that the first spring-travel delimiter 115 and the second spring-travel delimiter 127 encase the rod 119, and that the first securing element 109 is a monolithic constituent part of the rod 119.

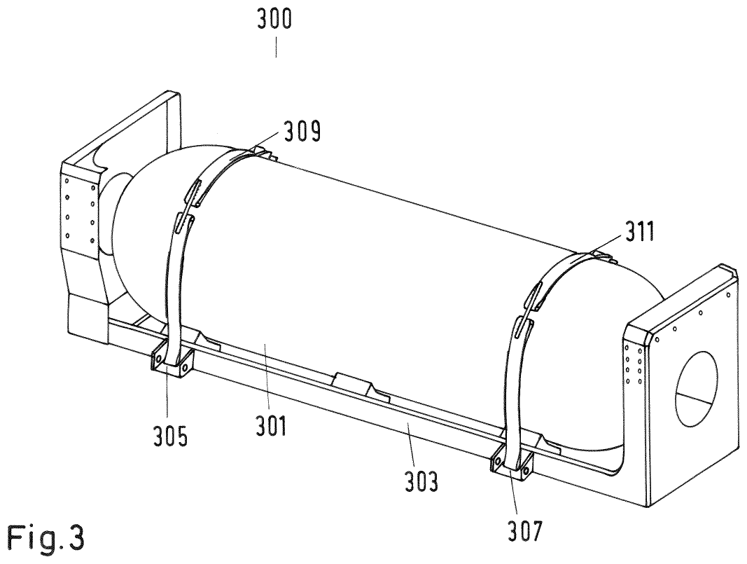

A pressure tank system 300 is illustrated in FIG. 3. The pressure tank system 300 comprises a round pressure tank 301, a frame 303 having a first holding point 305 and an additional holding point 307, and a first securing system 309 and a second securing system 311.

The pressure tank 301 is secured on the frame 303 by the first securing system 309 and the second securing system 311.

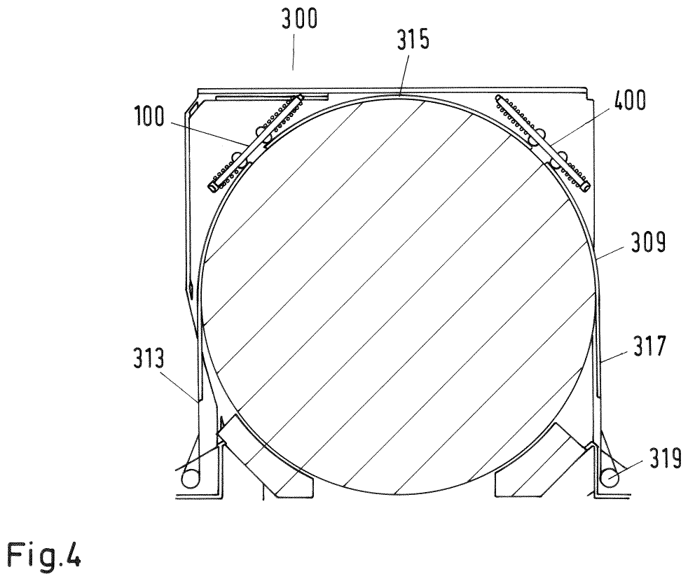

A cross section of the pressure tank system 300 is illustrated in FIG. 4. It can be seen here that the first securing system 309 comprises a first strap 313, a second strap 315 and a third strap 317.

The first strap 313 is connected to a first coupling system 100 and the first holding point 307.

The second strap 315 is connected to the second securing system 311 and the first coupling system 100.

The third strap 317 is connected to a second coupling system 400 and a second holding point 319.

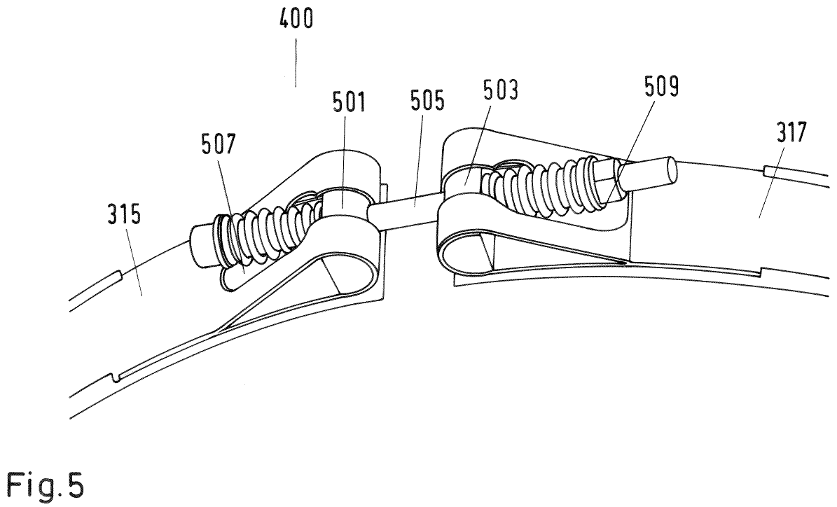

The second coupling system 400 of the pressure tank system 300 is illustrated in detail in FIG. 5. It can be seen here that connecting elements 501 and 503 of the coupling system 400 engage in a lug formed by the second strap 315 and the third strap 317 and surround a rod 505 on both sides in such a way that the rod 505 is guided through clearances 507 and 509 in the lugs.

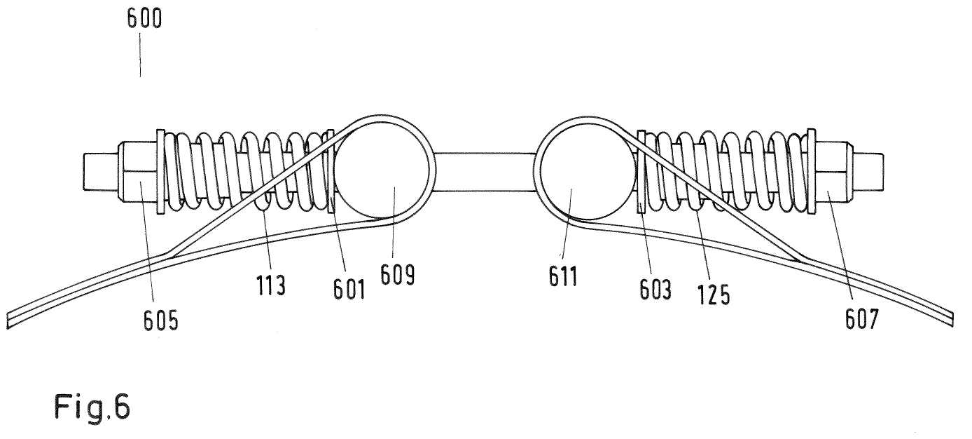

A coupling system 600 is illustrated in FIG. 6. The coupling system 600 is based on the coupling system 100 according to FIG. 1, wherein an additional contact disk 601, or 603, is disposed between a first connecting element 609 and the first spring element 113, or between a second connecting element 611 and the second spring element 125, respectively.

The shape of the first connecting element 609 and of the second connecting element 611 has changed in comparison to the coupling element 100 according to FIG. 1 in such a manner that the first connecting element 609 and the second connecting element 611 do not have any flat region, or have a completely round cross section, respectively.

As a result of the additional contact disks 601 and 603, and of the round shape of the first connecting element 609 and of the second connecting element 611, a movement of the first connecting element 609 is transmitted directly to the first spring element 113, or a movement of the second connecting element 611 is transmitted directly to the second spring element 125, so that any play in the movement between the connecting elements 609, 611 and the spring elements 113, 125 is minimized.

Furthermore, the coupling elements 600 comprises on both ends a threaded connection 605, 607 by way of which the spring elements 113, 125 can be tensioned, i.e. pre-tensioned, or re-tensioned.

The invention is not restricted to any one of the embodiments described above but may be modified in many different ways.

All of the features and advantages derived from the claims, the description and the drawing, including structural details, spatial arrangements and method steps, may be essential to the invention individually as well as in the most varied combinations.

Furthermore, in general, while a multitude of embodiments may have been depicted and described with a multitude of components in each embodiment, in alternative embodiments the components of various embodiments could be intermixed, combined, and/or exchanged for one another. In other words, components described in connection with a particular embodiment are not necessarily exclusive to that particular embodiment.

As used herein, the terms “general,” “generally,” and “approximately” are intended to account for the inherent degree of variance and imprecision that is often attributed to, and often accompanies, any design and manufacturing process, including engineering tolerances, and without deviation from the relevant functionality and intended outcome, such that mathematical precision and exactitude is not implied and, in some instances, is not possible.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

List of reference numerals

| | |
|---|---|
| 100 | Coupling system |
| 101 | Coupling interface |
| 103 | First strap |
| 105 | Second strap |
| 107 | Second strap |
| 109 | First securing element |
| 111 | First contact disk |
| 113 | First spring element |
| 115 | First spring-travel delimiter |
| 117 | First connecting element |
| 119 | Rod |
| 121 | Second securing element |
| 123 | Second contact disk |
| 125 | Second spring element |
| 127 | Second spring-travel delimiter |
| 129 | Second connecting element |
| 200 | Securing system |
| 300 | Pressure tank system |
| 301 | Pressure tank |
| 303 | Frame |
| 305 | First holding point |
| 307 | Additional holding point |
| 309 | First securing system |
| 311 | Second securing system |
| 313 | First strap |
| 315 | Second strap |
| 317 | Third strap |
| 319 | Second holding point |
| 400 | Coupling system |
| 501 | Connecting element |
| 503 | Connecting element |
| 505 | Rod |
| 507 | Clearance |
| 509 | Clearance |
| 600 | Coupling system |
| 601 | Contact disk |
| 603 | Contact disk |
| 605 | Threaded connection |
| 607 | Threaded connection |

1. A coupling system for mechanically coupling straps,
wherein the coupling system comprises a number of coupling interfaces;
wherein each coupling interface of the number of coupling interfaces comprises:
a rod;
a spring element;
a spring-travel delimiter;
a connecting element;
a securing element;
wherein the connecting element is movably disposed on the rod and is configured to be connected to a strap;
wherein the securing element is fixedly disposed on the rod;
wherein the spring element is disposed between the connecting element and the securing element;
wherein the spring-travel delimiter is disposed between the connecting element and the securing element on the rod;
wherein the spring-travel delimiter is shorter than the spring element in such a way that the spring-travel delimiter establishes a force fit between the connecting element, a strap connected to the connecting element, and the rod when the connecting element pushes by way of a defined force in the direction of the securing element.

2. The coupling system as claimed in claim 1, wherein
the rod has a thread for screwing the securing element thereto only in regions;
wherein the securing element is a threaded nut; and
wherein the thread ends in a region which in the relaxed state of the coupling system is spaced apart from the connecting element by a distance greater than a length of the spring-travel delimiter.

3. The coupling system as claimed in claim 1, wherein
the securing element is a fixed material protrusion of the rod that ends in a region which in the relaxed state of the coupling system is spaced apart from the connecting element by a distance greater than a length of the spring-travel delimiter.

4. The coupling system as claimed in claim 1,
wherein
the spring-travel delimiter is movably disposed between the connecting element and the securing element on the rod,
or is fixedly disposed on the securing element.

5. The coupling system as claimed in claim 1,
wherein
the coupling system comprises two coupling interfaces which are conjointly disposed on a rod.

6. A securing system for securing a round pressure tank (301), wherein the securing system comprises:
a strap system;
a number of coupling systems as claimed in claim 1;
wherein the strap system comprises a multiplicity of straps;
wherein the strap system is configured to be connected to a first holding point and a second holding point, and to encompass the pressure tank between the first holding point and the second holding point;
wherein the strap system is mechanically coupled to the number of coupling systems.

7. The securing system as claimed in claim 6, wherein
the strap system comprises a first strap which on its first end is connectable to the first holding point, and on its second end is connected to a connecting element of a coupling system of the number of coupling systems; and
the strap system comprises a second strap which on its second end is connectable to the second holding point, and on its second end is connected to a connecting element of a coupling system of the number of coupling systems.

8. The securing system as claimed in claim 6, wherein
the securing system comprises a first coupling system as, and a second coupling system; and
the strap system comprises three straps;
wherein a first strap of the strap system on its first end is connectable to the first holding point, and on its second end is connected to a first connecting element of the first coupling system;
wherein a second strap of the strap system on its first end is connected to a second connecting element of the first coupling system, and on its second end is connected to a first connecting element of the second coupling system;
wherein a third strap of the strap system on its first end is connected to a second connecting element of the second coupling system, and on its second end is connectable to the second holding point.

9. A pressure tank system for storing a fluid; wherein the pressure tank system comprises:
a round pressure tank;
a frame having a first holding point and a second holding point;
a securing system as claimed in claim 6;
wherein the securing system encases the pressure tank (301) at least in regions; and
wherein the securing system is connected to the first holding point and the second holding point.

10. A method for securing a pressure tank, in which method a pressure tank having a securing system as claimed in claim 6 is secured on a number of holding points.
